(19) United States
(12) Patent Application Publication
(10) Pub. No.: US 2021/0306456 A1
(43) Pub. Date: Sep. 30, 2021

(54) INTELLIGENT TELEPHONE CALL BLOCKING AND MANAGEMENT

(71) Applicant: Vamsee Dheeraj Kanagala, Santa Clara, CA (US)

(72) Inventor: Vamsee Dheeraj Kanagala, Santa Clara, CA (US)

(21) Appl. No.: 16/827,714

(22) Filed: Mar. 24, 2020

(51) Int. Cl. H04M 3/436

(52) U.S. Cl. CPC H04M 3/4365

(57) ABSTRACT

An intelligent telephone management and blocking system distributed over one or more backend servers and a remote calling device. The system provides a platform that allows a user to configure rules that process incoming telephone calls in a customized manner for the user. For example, rules can be used to determine how incoming telephone calls are managed. The rules may be generated based on the number itself, the time of call, one or more conditions detectable by the phone, geography, and other parameters. Based on the generated rules, the present system may better detect robo-calls, spam, and other unwanted calls for a user, and block or otherwise handle the calls in an efficient manner on behalf of the user.

### BACKGROUND

Robo-calls and spam have become a large industry in several countries. With the growth of their popularity, the level of annoyance they present has increased amount with call recipients as well. Many robo-calls and spam calls are difficult to detect, as the calling phone numbers change and the opening statements vary. Though some regions implement a “Do Not Call” registry, these registries are not always effective against spam calls, as the callers change their origination phone numbers or company behind the calls. What is needed is an improved method for handing phone calls.

### SUMMARY

The present technology, roughly described, includes an intelligent telephone management and blocking system. The system may be distributed over one or more backend servers and a mobile application stored and executing on a calling device (e.g., a mobile telephone). The system provides a platform that allows a user to configure rules that process incoming telephone calls in a customized manner for the user. For example, rules can be used to determine how incoming telephone calls are managed. The rules may be generated based on the number itself, the time of call, one or more conditions detectable by the phone, geography, and other parameters. Based on the generated rules, the present system may better detect robo-calls, spam, and other unwanted calls for a user, and block or otherwise handle the calls in an efficient manner on behalf of the user.

In some instances, a telephone call from an unknown caller may be handled by providing a challenge for the caller to complete. The call may be connected or blocked based on the caller's response to the challenge. The platform may provide for trusted contacts which form a “circle of trust.” The user may have access to additional information for each trusted contact, such as for example a trusted contact's location, call log, and voicemails, and may record conversations with trusted contacts.

In embodiments, a method is disclosed for processing an incoming phone call. The method includes receiving, by a server, a call intended for a first phone number from a telephone network. The call can originate from a first remote device associated with a calling number. One or more rules are accessed to apply to the received call before the call is accepted. The one or more rules are accessed from account data by the server and associated with the first phone number. The server can have access to a plurality of rule sets for a plurality of phone numbers, wherein at least two of the plurality of rule sets are different for at least two of the plurality of phone numbers. A challenge can be provided by the server to the originator of the call. A response can be received by the server to the challenge from the originator of the call. A determination is made as to whether to connect the call between the first remote device and a second remote device based on the response received by the server.

In embodiments, a non-transitory computer readable storage medium includes a program, the program being executable by a processor to perform a method for processing an incoming phone call. The method includes receiving, by a server, a call intended for a first phone number from a telephone network. The call can originate from a first remote device associated with a calling number. One or more rules are accessed to apply to the received call before the call is accepted. The one or more rules are accessed from account data by the server and associated with the first phone number. The server can have access to a plurality of rule sets for a plurality of phone numbers, wherein at least two of the plurality of rule sets are different for at least two of the plurality of phone numbers. A challenge can be provided by the server to the originator of the call. A response can be received by the server to the challenge from the originator of the call. A determination is made as to whether to connect the call between the first remote device and a second remote device based on the response received by the server.

In embodiments, a system for processing an incoming phone call includes a server comprising one or more processors, memory, and a plurality of modules. The modules are stored in memory and executed by the one or more processors to receive, by a server, a call intended for a first phone number from a telephone network, the call originating from a first remote device associated with a calling number, access one or more rules to apply to the received call before the call is accepted, the one or more rules accessed from account data by the server and associated with the first phone number, the server having access to a plurality of rule sets for a plurality of phone numbers, wherein at least two of the plurality of rule sets are different for at least two of the plurality of phone numbers, provide a challenge by the server to the originator of the call, receive a response by the server to the challenge from the originator of the call, and determine whether to connect the call between the first remote device and a second remote device based on the response received by the server

### BRIEF DESCRIPTION OF FIGURES

FIG. 1 is a block diagram of a system for handling telephone calls outside a PTSN network.

FIG. 2 is a block diagram a system for handling telephone calls inside a PTSN network.

FIG. 3 is a block diagram a server application for managing telephone calls.

FIG. 4 is a block diagram a mobile device application for handling telephone calls.

FIG. 5 is a method for managing telephone calls.

FIG. 6 is a method for creating a blocking rule.

FIG. 7 is a method for creating a blocking rule based on a calling telephone number.

FIG. 8 is a method for creating a blocking rule based on time.

FIG. 9 is a method for creating a blocking rule based on a condition.

FIG. 10 is a method for creating a blocking rule based on geography.

FIG. 11 is a method for generating a caller challenge.

FIG. 12 is a method for configuring voicemail.

FIG. 13 is a method for generating a caller challenge.

FIG. 13 is a method for accessing trusted contact information.

FIG. 14 is a method for handling an incoming call.

FIGS. 15-44 are screenshots for a mobile application that that intelligently manages telephone calls.

FIG. 45 is a block diagram of a computing environment for implementing a computing device.

### DETAILED DESCRIPTION

The present technology is an intelligent telephone management and blocking system. The system may be distributed over one or more backend servers and a mobile application stored and executing on a calling device (e.g., a mobile telephone). The system provides a platform that allows a user to configure rules that process incoming telephone calls in a customized manner for the user. For example, rules can be used to determine how incoming telephone calls are managed. The rules may be generated based on the number itself, the time of call, one or more conditions detectable by the phone, geography, and other parameters. Based on the generated rules, the present system may better detect robo-calls, spam, and other unwanted calls for a user, and block or otherwise handle the calls in an efficient manner on behalf of the user.

In some instances, a telephone call from an unknown caller may be handled by providing a challenge for the caller to complete. The challenge, for example an audio captcha challenge, may include answering a question, solving an equation, or following instructions using the mobile device. If the caller of the incoming call does not complete the challenge, the telephone number it can be blocked. If a caller does complete the challenge, the call may be connected to the user or otherwise processed according to user preferences.

A user of the present system may configure trusted contacts. The user may have access to additional information for each trusted contact. For example, a user may access a trusted contacts location, call log, voicemails, and may record conversations with trusted contacts. In some instances, an employer may configure employees as trusted contacts, and can monitor employees during business hours with access to the additional information.

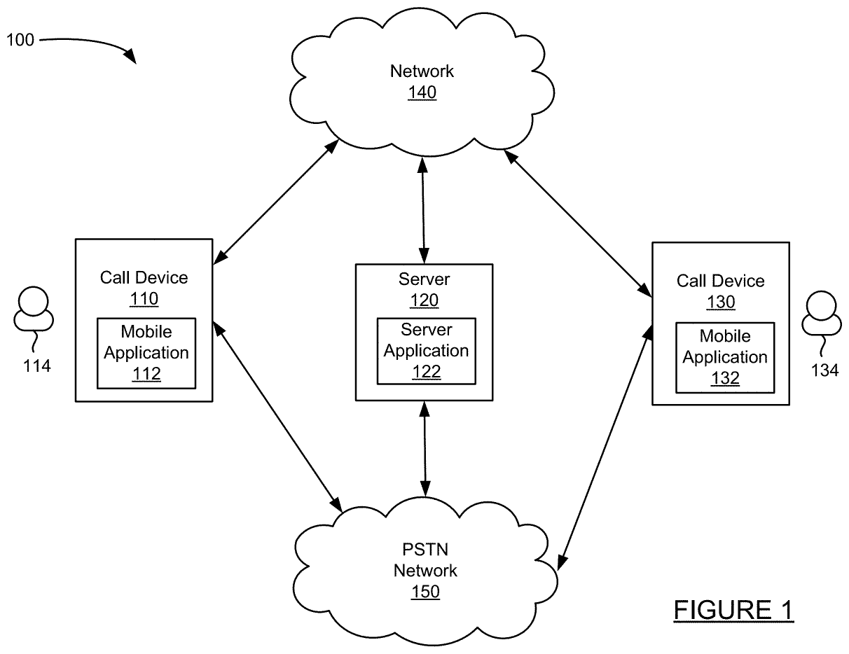

FIG. 1 is a block diagram of a system for handling telephone calls outside a public switch telephone network (PSTN). The system 100 of FIG. 1 includes call device 110, server 120, call device 130, network 140, and public switched telephone network (PSTN) 150. Call device 110 includes mobile application 112 and call device 130 includes mobile application 132. Call devices 110 and 130 may be implemented as any device that may handle phone calls and executes an application. Examples of call devices 110 and 130 include mobile phones, laptop computers, tablet computers, and other devices capable of making a phone call and storing and executing software.

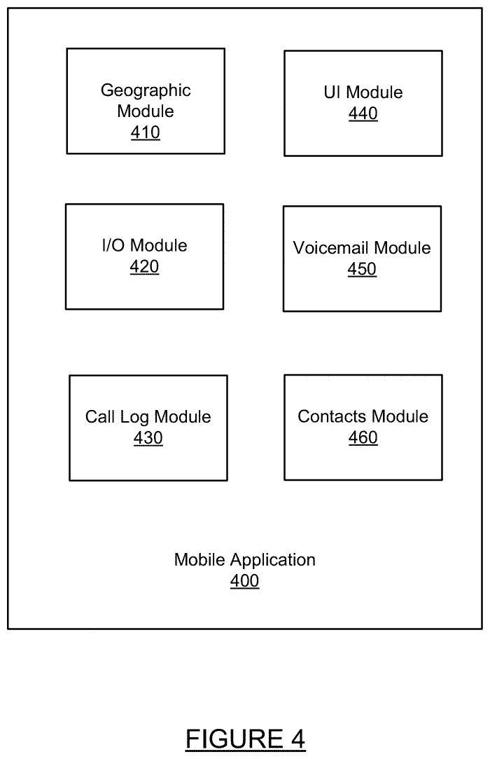

Mobile application 112 may implement at least a portion of the functionality of the present system on a mobile device. For example, mobile application 112 may implement a calling application through which a user may send and receive calls on the call device 110, provide one or more graphic user interfaces, and so forth. In some instances, mobile application 112 may replace a native phone application on a mobile phone, such as for example a phone mobile app provided on an iPhone by Apple Computer, or a mobile phone provided by Samsung. Mobile application 112 and 132 are discussed in more detail with respect to FIG. 4.

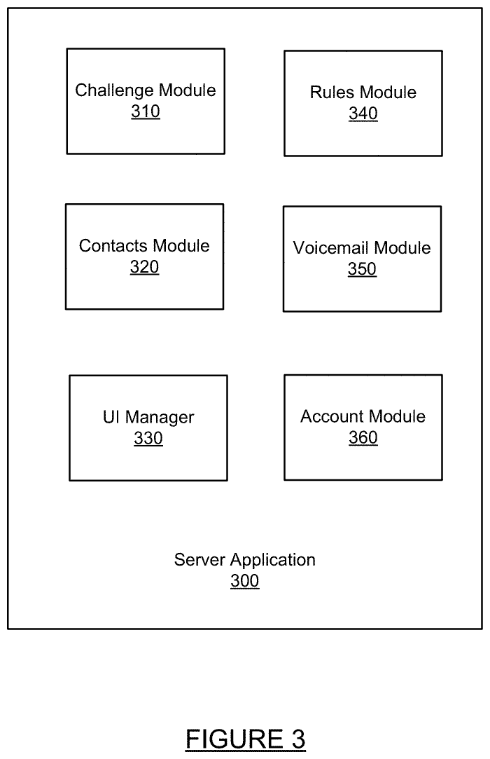

A user 114 at call device 110 may initiate a call to a telephone number associated with device 130. The call will initially be routed to PSTN network 150, which will then provide call information to server application 122 on server 120. Server application 122 may perform at least a portion of the functionality described herein, including routing incoming phone calls intended for the recipient device, applying rules to incoming phone calls, and other functionality. In the system of FIG. 1, if application server 122 determines the call should be connected, application 122 connects the call from call device 110 to call device 130. Server application 122 is discussed in more detail with respect to FIG. 3.

PSTN network 150 may include one or more circuit switched telephone networks operated by telephone operators, including national, regional, and local operators. The PSTN network provides infrastructure and services for public telecommunications and can consist of telephone lines, fiber-optic cables, microwave transmission links, cellular networks, communication satellites, telephone cables, and other communication systems, all interconnected by switching centers, allowing telephones communicate with each other. In some instances, when a call device 110 attempts a call with a telephone number associated with call device 130, the call will first be routed to PSTN network 150. PSTN network may then route the call to server 120, which may then perform methods described herein to block the call, provide a challenge to a user 114 associated with call device 110, provide a customized voicemail, or connect the call to call device 130.

Mobile applications 112 and 132 may also communicate with server application 122 through network 140. Network 140 may be implemented as any combination of private networks, public networks, the Internet, an intranet, a Wi-Fi network, a cellular network, a wide area network, local area network, or any other network over which Digital Communications may occur. In some instances, either mobile application can communicate with server application 122 to create an account, perform login, configure settings, set up blocking rules, and other aspects and features of the technology described herein.

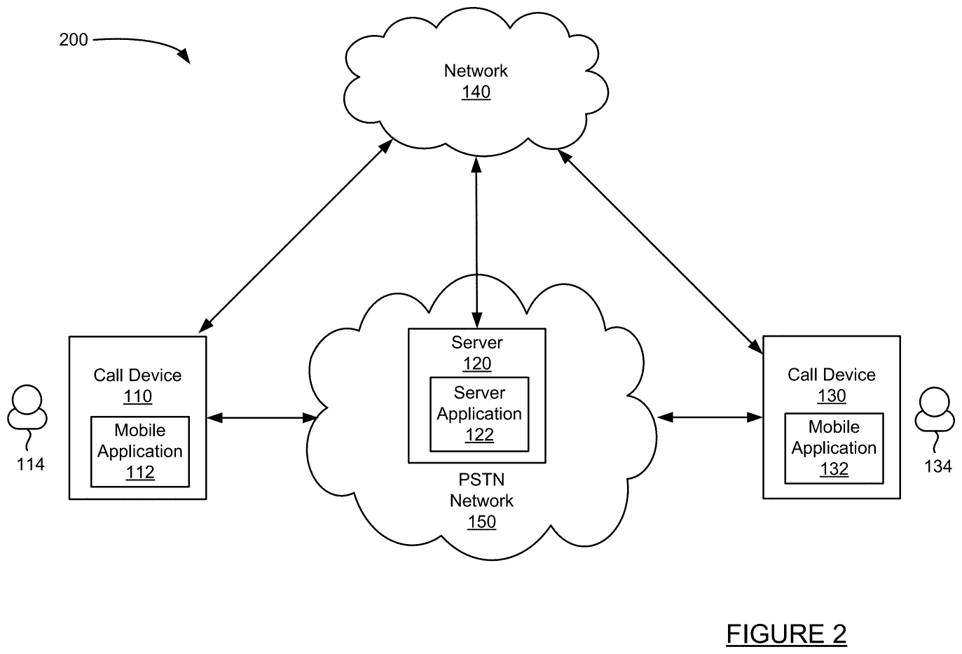

FIG. 2 is a block diagram a system for handling telephone calls inside a PTSN network. The system 200 of FIG. 2 includes call device 110, server 120, call device 130, network 140, and public switched telephone network (PSTN) network 150.

System 200 of FIG. 2 is similar to system 100 of FIG. 1, except that server 120 and server application 122 are implemented within PSTN network 150. In the example illustrated in FIG. 2, server 120 may be implemented by a telephone carrier as part of PSTN network 150, rather than an external service that communicates with a telephone carrier as illustrated in system 100 of FIG. 1. In the system of FIG. 2, a call from call device 110 to call device 130 may be received by PSTN 150, routed to server 120 and application 122 within network 150, be processed by application 122, and then blocked, sent to voicemail, connected to call device 130, or otherwise processed by application 122.

FIG. 3 is a block diagram a server application for managing telephone calls. Server application 300 of FIG. 3 provides more detail of server application 122 and FIGS. 1 and 2. Server application 200 may include one or modules or engines that perform functions described herein. The modules 310-360 described with respect to FIG. 3 are exemplary, and additional or fewer modules may be implemented to perform the functionality described herein.

Server application 300 includes challenge module 310, contacts module 320, user interface module 330, rules module 340, voicemail module 350, and account module 360. Challenge module 310 manages challenge settings for individual phone numbers, configuring challenges, providing challenge messages, and evaluating challenge responses. Contacts module 320 may manage contacts for a particular account telephone number and preferences set for a particular contact. UI module 330 may provide user interface data through a local display device. The user interface graphics and content can be received from a remote application server, stored locally on the device, or a combination of the two. Rules module 340 may configure rules based on user input and other information for each phone number, apply rules to incoming telephone calls, and access rules for a particular telephone number. Voicemail module 350 may manage different voicemails for each telephone number account and for the user. Account module 360 may manage new accounts, perform login, perform account maintenance, and perform other general aspects of user accounts.

FIG. 4 is a block diagram of a mobile device application for handling telephone calls. Mobile application 400 of FIG. 4 provides more detail for mobile application 112 and mobile application 132 of FIGS. 1 and 2. Mobile application 400 may include one or modules or engines that perform functions described herein. The modules 410-460 described herein are exemplary, and additional or fewer modules may be implemented to perform the functionality described herein.

Mobile application 400 includes geographic module 410, input output module 420, call log module 430, user interface module 440, voicemail module 450, and contacts module 460. Geographic module 410 may access geographic information from the local device on which mobile application 400 is installed, provide that data to an application server, and access geographic information associated with an incoming call. Input output module 420 may handle input received through mobile application 400, such as voice input, dial tone input, and touchscreen input, and provide output to external machines, such as an application server. Call log module 430 may access local call logs and transmit the call logs to an application server. User interface module 440 may provide user interface data, for example data received from an application server, to a mobile device or other device. Voicemail module 450 may manage different voicemails for each telephone number account. Contacts module 460 may manage contacts for the user of the mobile device on which mobile application 400 is installed.

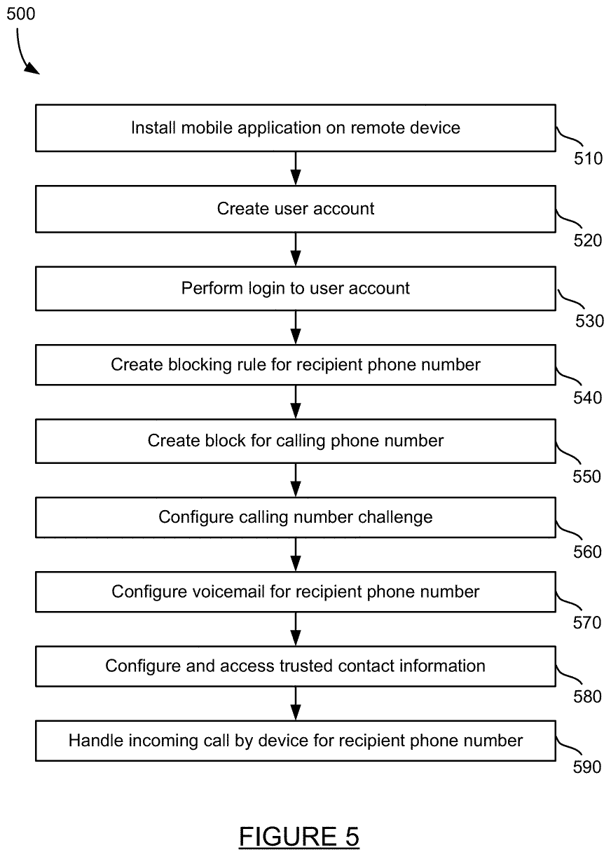

FIG. 5 is a method for managing telephone calls. Method 500 of FIG. 5 begins with installing a mobile application on a remote device at step 510. The remote device may be remote from an application server, and may include a calling device 110 or 130 of FIGS. 1 and/or 2. The mobile application may be installed, for example, from a mobile application store provided from a network page or a web page, and associated with the platform being implemented by the mobile device.

A user account may be created at step 520. The user account may be created with a username, password, telephone number, user preferences, and other user data. A user may login to the user account at step 530. Login may include providing a username and password, a phone number and password, a biological footprint, or other information to log into the user's account. In some instances, the user account data may be stored at an application server or a data store local or remote from an application server (not illustrated in FIGS. 1-2).

Steps 540-590 are listed in the order shown in FIG. 5, but the steps may be performed in a different order. The order of the steps is provided for purposes of discussion only, and is not intended to be limiting.

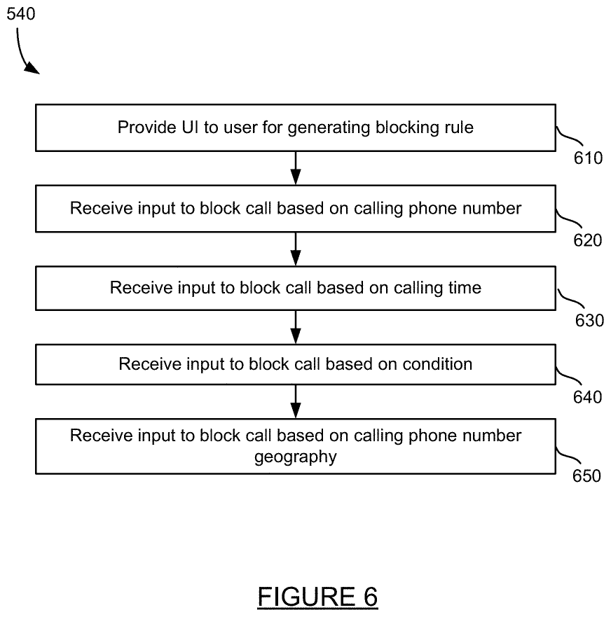

A blocking rule may be created for a recipient phone number at step 540. In some instances, users with an account may create one or more rules for blocking or managing incoming phone calls for which their phone number is the intended recipient of the call. Creating a blocking rule may include configuring one or more rules to block a call based on the calling number, time, condition, or geography. More detail for creating a blocking rule is discussed with respect to the method of FIG. 6.

A calling phone number may be added to a block list at step 550. In this instance, a particular phone number may be prevented from establishing a phone call with the recipient phone number logged into the user account. The blocked phone number may be a contact of the logged in user or a non-contact phone number.

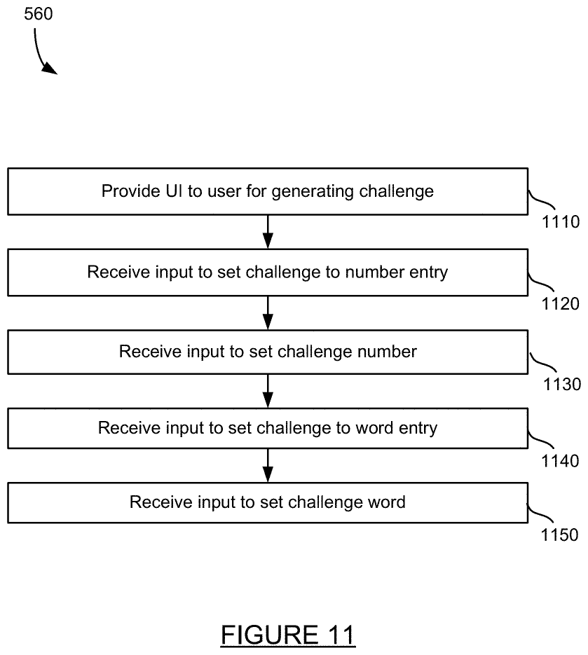

A calling number challenge may be configured at step 560. The challenge may be configured based on the calling phone number or a rule, and may include one of several types of challenges. Configuring a calling number challenge is discussed in more detail below with respect to the method of FIG. 11.

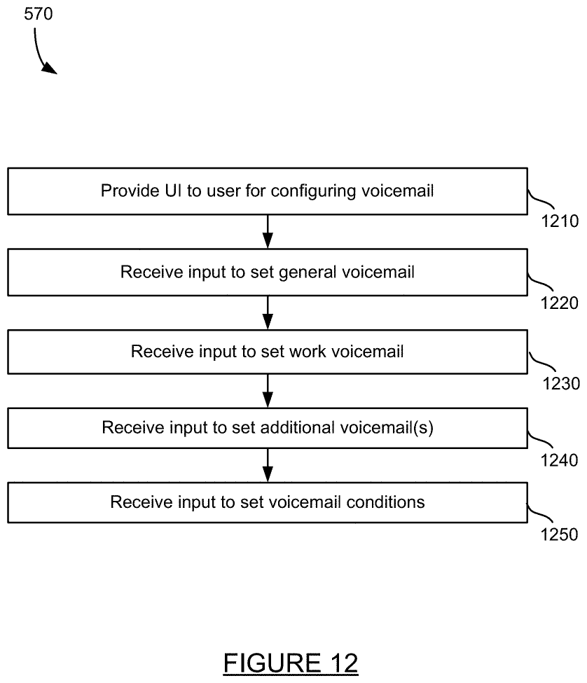

Voicemail for a recipient phone number may be configured at step 570. Configuring voicemail may include setting a general voicemail, a work voicemail, contact specific voicemails, conditional voicemails, voicemail access, and other voicemail settings. Configuring voicemails for a user is discussed in more detail with respect to the method of FIG. 12.

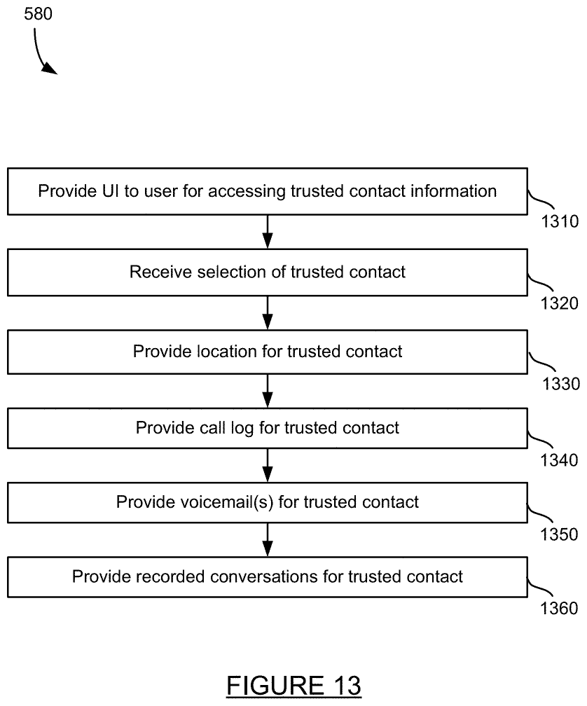

Trusted contact information may be configured and accessed at step 580. In some instances, a user may provide certain trusted users with access to the user voicemails, call log, geographic location, call recordings, and other content. These trusted contacts can be considered a “circle of trust” for which the user shares this level of information. Configuring and accessing trusted contact information is discussed in more detail below with respect to the method of FIG. 13.

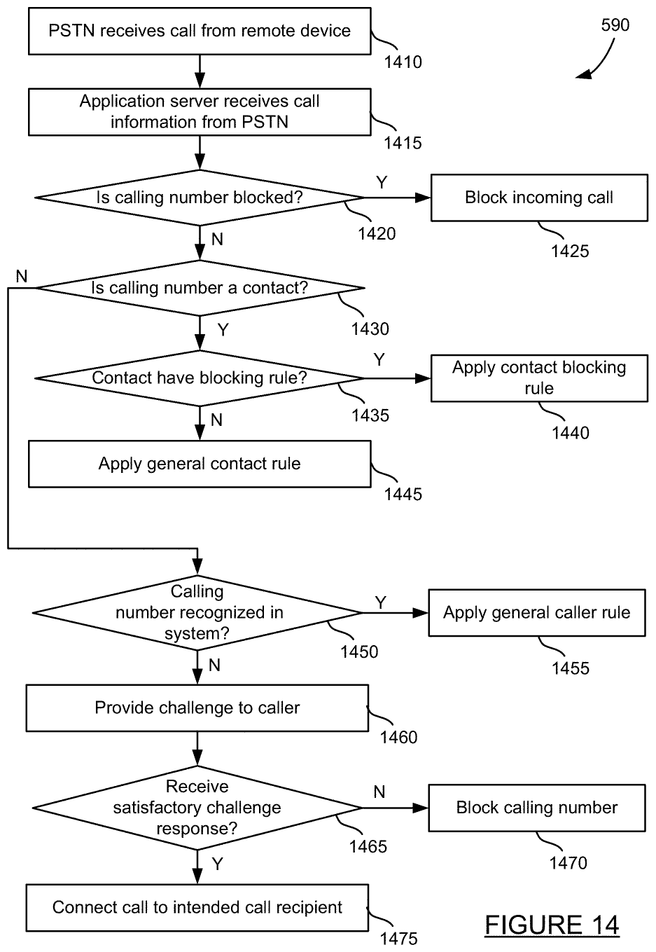

An incoming call is handled for a recipient phone number at step 590. As discussed above, an incoming call may be handled at any point in the method of FIG. 5. Handling an incoming call may include applying one or more rules to the incoming call, presenting a challenge to the caller initiating the call, determining a voicemail to provide to the caller, blocking the call, and/or performing other functions to the incoming call. Handling an incoming call by a device for a recipient phone number is discussed in more detail with respect to the method of FIG. 14.

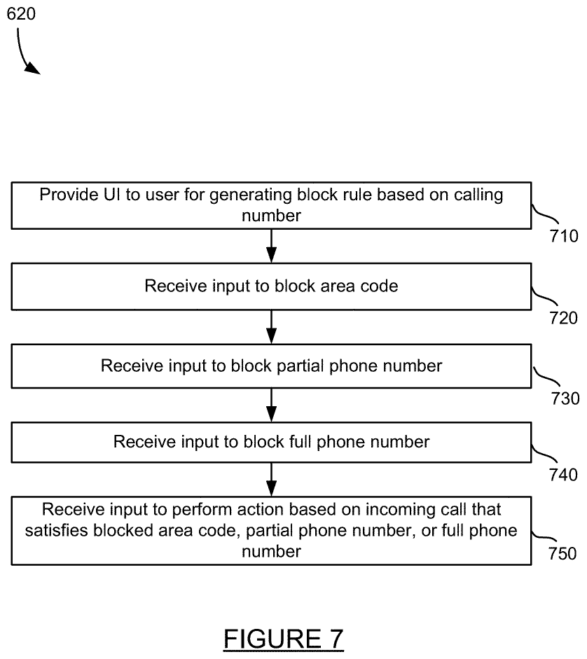

FIG. 6 is a method for creating a blocking rule. The method of FIG. 6 provides more detail for step 540 of the method of FIG. 5. First, a user interface is provided to a user through a mobile device for generating a blocking rule at step 610. The user interface may be provided by a mobile application and received from a server application over a network. Input can be received to block a call based on a calling phone number at step 620. The input may specify whether to block a call based on an area code, entire phone number, or other portions of the phone number. Receiving input to block a call based on a calling phone number is discussed in more detail with respect to the method of FIG. 7.

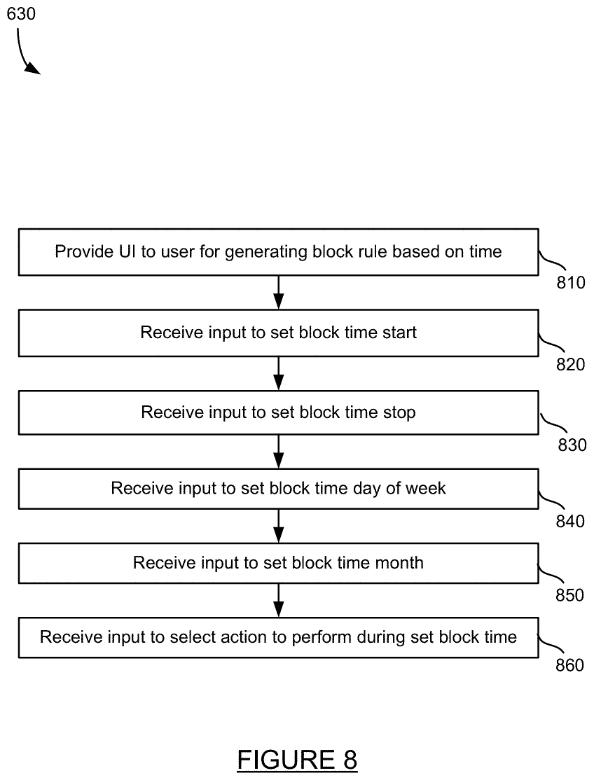

Input may be received through a user interface to block a call based on the calling time of the call at step 630. In some instances, a rule may be generated to block the call based on the time, day, week, month, or other temporal information associated with the call. More detail for receiving input to block a call based on a calling time is discussed with respect to the method of FIG. 8.

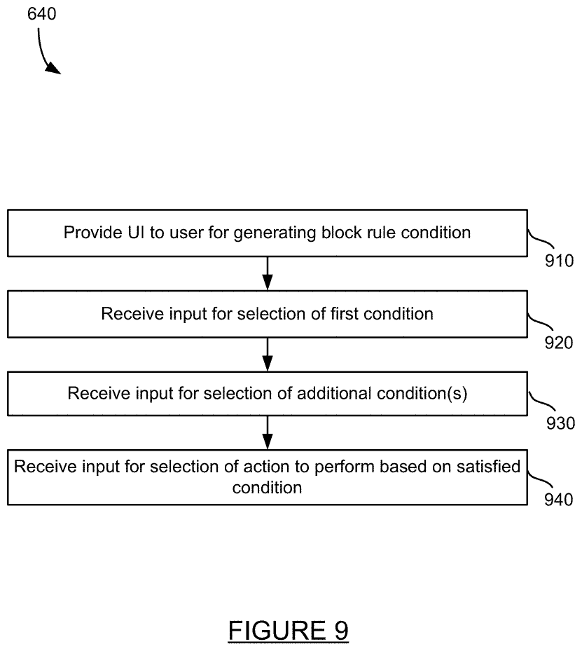

Input is received to block a call based on a particular condition at step 640. In some instances, a call may be blocked or sent directly to voicemail based on one or more conditions. The conditions may be based on user activity, information retrieved from remote servers, and/or other data. More detail for receiving input to block a call based on a condition is discussed with respect to the method of FIG. 9.

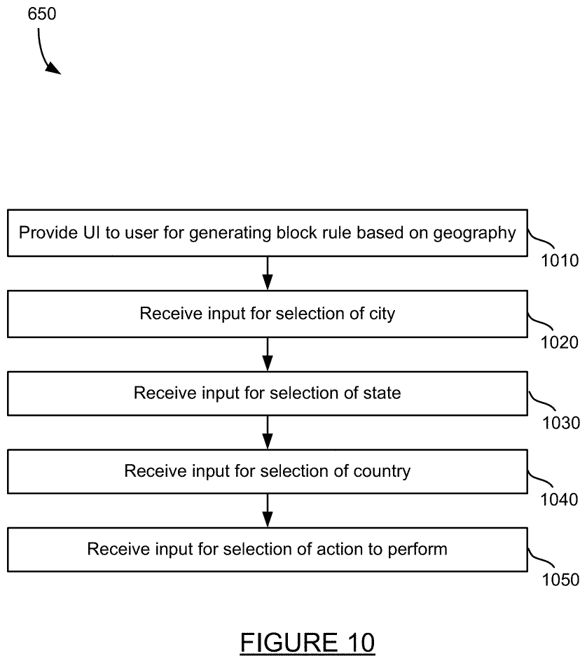

Input is received to block a call based on the calling phone number geography at step 650. In some instances, a caller may be blocked based on the geography associated with the calling phone number. For example, an incoming call may be blocked on geography aspects such as a city, state, country, or other geographical locale associated with the phone number. Additional details for receiving input to block a call based on a calling phone number geography is discussed with respect to method of FIG. 10.

FIG. 7 is a method for creating a blocking rule based on a calling telephone number. The method of FIG. 7 provides more detail for step 620 of the method of FIG. 2. First, a user interface is provided to a user for generating a blocking rule based on a calling number at step 710. Input may then be received through the provided interface to block a call based on a calling number area code at step 720. For example, input may be received to block all calls that have a “712” area code. Input may be received a block a partial phone number at step 730. For example, input may be received through the provided user interface to block calls from telephone numbers that include the same area code and first three numbers of the calling phone number (e.g., block calls from numbers starting with the seven digits matching 408-745-xxxx). Input may be received to block a full phone number at step 740. This may have the same effect as step 550 of the method of FIG. 5, but can be performed as a rule rather than added to a block list.

Input is received to perform an action based on the incoming call that satisfies a blocked area code, partial phone number, or full phone number at step 750. The input may define a particular action, such as send a call directly to voicemail, present a challenge to an incoming caller that matches a calling number blocking rule, block the call, connect the call to the mobile application on the user's device, or some other action.

FIG. 8 is a method for creating a blocking rule based on time. The method of FIG. 8 provides more detail for step 630 of the method of FIG. 6. First, a user interface is provided to a user for generating a blocking rule based on the time of an incoming call. Input is received to set a block time start at step 820. The start of the block time may be set to any time and in any time zone, such as for example 8:00 AM, 9:00 AM, 10:30 AM, or 3:45 PM PST, or any other time. Input may be received to set the blocking stop time at step 830. The stop time can be any time after the start time received at step 820. In some instances, input may be received to set a block time day of the week at step 840. For example, not only can calls be blocked for certain time periods, but on certain days a week as well, such as blocking all calls on Sundays.

An input may be set to block calls for a particular month, or a range of days, at step 850. Input may then be selected to perform an action to perform during the set block time at step 860. The input may define a particular action, such as send a call directly to voicemail, present a challenge to an incoming caller that matches a calling number blocking rule, block the call, or some other action.

FIG. 9 is a method for creating a blocking rule based on a condition. The method of FIG. 9 provides more detail for step 640 of the method of FIG. 6. First, the user interface is provided to a user for generating a block rule condition at step 910. Input is received for selection of a first condition at step 920. A condition may be any state that can be detected by a device on which a mobile application is executing, or any state that can be detected or determined by an application server. In some instances, a condition can include whether the user is currently scheduled to be in a meeting, whether the user appears to be walking, moving or exercising (e.g., as detected by mobile device motion sensors), whether the user is on the phone, is determined to be driving, or some other condition.

Input may be received for selection of additional conditions at step 930. In some instances, a call may be blocked if a plurality of conditions is satisfied, such as for example if a call is received outside of business hours and a user is determined to not be at a geographical location associated with his or her workplace.

Input can be received for selection of an action to perform based on whether one or more of the satisfied conditions are met at step 940. The input may define a particular action, such as send a call directly to voicemail, present a challenge to an incoming caller that matches a calling number blocking rule, block the call, or some other action.

FIG. 10 is a method for creating a blocking rule based on geography. The method of FIG. 10 provides more detail for step 650 of the method of FIG. 6. A user interface is provided to a user for generating a block rule based on geography at step 1010. Input is received through the provided interface for selection of a city at step 1020. The city may be a city in the United States, a city in a foreign country, town, or any other locale associated with area codes and/or phone numbers. Input for a selection of a state from which to block calls can be received at step 1030. Input for a particular country from which to block calls from can be received through the provided user interface at step 1040. Input may then be received for selection of an action to perform if a call is received that satisfies any of the received input for a city, state, or country in steps 1020-1040. The input may define a particular action, such as send a call directly to voicemail, present a challenge to an incoming caller that matches a calling number blocking rule, block the call, or some other action.

FIG. 11 is a method for generating a caller challenge. The method of FIG. 11 provides more detail for step 560 of the method of FIG. 5. First, a user interface is provided to the user by the mobile application, and received by mobile application from the server application, for generating a challenge at step 1110. Input is received to set a challenge to a number entry at step 1120. Receiving input at step 1120 indicates that a challenge involving a number will be used for unknown callers. The input to set the challenge number is received at step 1130. In some instances, the challenge number may be requested from a caller through audio. For example, a message may be played as a captcha challenge to a caller such as, “please press three followed by two and then press pound.” In some instances, a number challenge may be presented to a caller in a manner such as, “please press the number two on your keypad three times.”

Input may be received through the provided user interface to set a challenge to a word entry challenge at step 1140. Input may then be received to set a challenge word at step 1150. For example, a challenge word may be “cat,” wherein the word is provided to a caller through an audio message and the user must touch phone dial numbers associated with the letters in the challenge word to spell the word. For example, for the challenge word of “cat,” the user would need to press “1” for the letter c, “2” for the letter a, and then “8” for the letter t, spelling the word “cat.”

The challenges discussed with respect to the method of FIG. 11 are exemplary, and other challenges may be used as well. In some instances, the challenges available may differ between users, and users can specify a different number of entries, word entries, or other aspects of challenges to present to callers attempting to place a phone call to the particular user.

FIG. 12 is a method for configuring voicemail. The method of FIG. 12 provides more detail for step 570. User interface is provided to user for configuring voicemail at step 1210. First, input may be received to set a general voicemail at step 1220. The general voicemail may be a voicemail that is presented to contacts of the user and other incoming calls for which no other rule is applicable. Input can then be received to set a work voicemail at step 1230. A workforce mail may be applied to certain contacts associate with the business, contacts flagged as clients or work-related, or other work-related calling numbers. Input may be received to set additional voicemails at step 1240. Additional voicemails may include one or voicemails targeted to a spouse, child of the user, or some other contact of the user.

Input may be received at setup voicemail conditions at step 1250. The voicemail conditions may specify when the different voicemails are to be used. Voicemail conditions may be associated with a particular contact, a particular group of contacts, or all contacts. The conditions may include, for example, numbers, times, geography, and identification of specific contacts to receive one or more the particular voicemails at different times or under different circumstances.

In some instances, a user may set a condition such that one of several options can be set for voicemail, including but not limited to: 1) anyone can leave a voice message, and 2) validated people can leave a voice message. For the “anyone” setting, the phone allows anyone to call the user, such that each caller may be connected or be presented with a challenge (e.g., captcha puzzle). In some instances, anyone who fails the challenge may be directed to voicemail, as well as those that pass the captcha but for whom the user does not answer the phone. For the “validated people” setting, only validated people can leave a voice message for the user. If the setting is turned on by the user, callers who appear in the user's white list (e.g., contacts) and people who pass a challenge can leave a voice message.

In some instances, a user may set a pre-message greeting setting. The setting, if turned on, calls from phone numbers not in user's white list (e.g., contact list) will go directly to a warm-up intro message (one time, or a user specified number of times). During the warm-up intro, the user phone will not ring or provide any indication of a call. Hence, for an unknown number, a short message will be provided to the number, and the caller may leave a short message. If the user approves the number, the user may add the caller to a white list. If the user does not approve the number, or the user takes no action, the number will not be added to the user's white list.

FIG. 13 is a method for accessing trusted contact information. The method of FIG. 13 provides more detail for step 580 of the method of FIG. 5. A user interface is provided to a user for accessing trusted contact information at step 1310. A selection is received for a trusted contact at step 1320. In some instances, the user interface provided at step 1310 may show one or more of the user's trusted contacts that are within the user's “circle of trust.” One of these contacts can be selected by the user at step 1320. The geographic location for the selected trusted contact may be provided at step 1330. The location may be provided in terms of a map, geographical coordinates, the name of the city, an indication of whether the trusted contact is within a geographic fence (e.g., with a green light for within the fence or a red light for outside of the fence, or vice versa), or in some other manner. A call log for the trusted contact may be provided at step 1340. The call log may be provided as a file, a list of calls, statistics, or in some other fashion. Voicemails for the selected contact may be provided at step 1350. The voicemails may include a list of callers which can be selected, voicemail files, or some other information for the voicemails for the selected trusted contact. Recorded conversations for the selected trusted contact can be provided at step 1360. The recorded conversations may be listed by time and date, length, or with other information between the user and the trusted contact.

FIG. 14 is a method for handling an incoming call. FIG. 14 provides more detail for step 590 of the method of FIG. 5. The steps in the method of FIG. 14 can be provided in a different order than that illustrated in FIG. 14. The particular order of the steps in the method of FIG. 14 is merely for purposes of discussion, and is not intended to be limiting.

First, a PSTN receives a call from a remote device at step 1410. An application server then receives call information from the PSTN at step 1415. In some instances, the application server can be implemented within PSTN or external to PSTN.

A determination is made by an application on the application server as to whether the calling number is blocked by the user at step 1420. If the calling number is blocked by the user, the incoming call is blocked by the application at step 1425. If the calling number is not blocked, a determination can be made as to whether the calling number is a contact at step 1430. If the calling number is a contact, the method continues to step 1435 at which a determination is made as to whether the contact has a blocking rule to apply to the incoming call. If the contact has no blocking rule, a general contact rule can be applied to the incoming call at step 1445. In this instance, a general rule may be applied to the incoming call, such as for example time blocking rules, geography blocking rules, and other rules. If there is a blocking role specific to the contact, the contact specific blocking rule(s) are applied at step 1440. The contact specific blocking rules may be applied to determine how to handle the incoming call. If none of the contact specific blocking rules apply to the received call, then general contact rules may be applied to incoming call, similar to the application of a general contact rule at step 1445.

If the calling number is not associated with a contact for the user at step 1430, a determination is made as to whether the calling number is recognized in the system at step 1450. Although the calling number may not be a contact or be recognized by the intended recipient (the user of the mobile device receiving the call), the calling number may be recognized by a different user as a legitimate number, and thereby determined to not be a source of spam or an undesirable call. If the calling number is recognized in the system, for example by another user having an account with the present system, general caller rules may be applied to the incoming call at step 1455. The general caller rules may include sending the call to voicemail, connecting the call, or some other rule applied to legitimate callers.

If the calling number is not recognizing the system, a challenge may be provided to the caller at step 1460. The particular challenge may be based on whether the account associated with the recipient phone number has configured a number challenge, a word challenge, or whatever challenge has been configured for incoming calls.

A determination is then made as to whether a satisfactory challenge response is received from the originator of the call at step 1465. For example, the determination may identify whether a user correctly entered a challenge number, a challenge word, or other correct response for the particular challenge issued for the particular call. If a satisfactory response has not been received, then the calling number may be blocked at step 1470. If a satisfactory response has been received, the call may be connected to the intended recipient at step 1475.

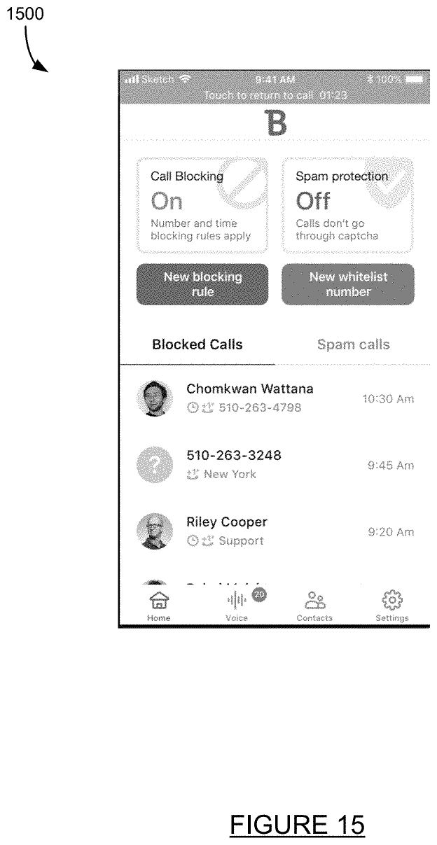

FIGS. 15-44 are screenshots of an interface provided by a mobile application that that intelligently manages telephone calls. The mobile application screenshots of FIGS. 14-44 are meant to be exemplary, and not intended to limit the functionality of the present system. Rather, they are examples of a user interface that may be used to provide portions of a user experience in the spirit of at least a portion of the technology described herein.

FIGS. 15-24 illustrate exemplary user interfaces for configuring blocking of a call. Interface 1500 of FIG. 15 provides a homepage for a mobile application that implements the present technology. The homepage includes an icon for turning call blocking on or off (currently on), an icon for turning spam protection on or off (currently off), a selectable button for generating a new blocking rule, a selectable button for adding a new white list number, a listing of blocked calls and spam calls, and a list of selectable buttons for the mobile application home screen, voicemail, contacts, and settings.

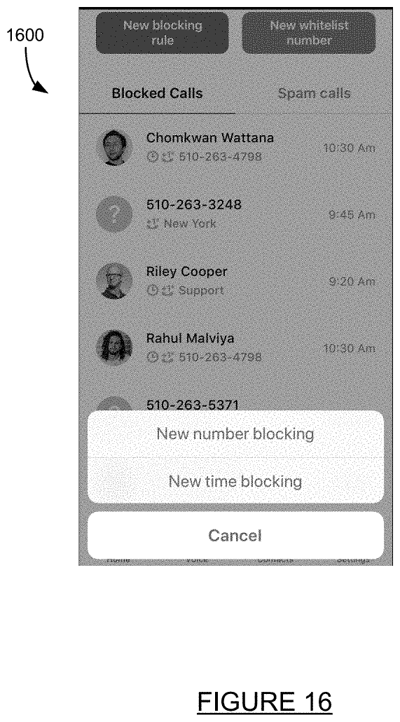

When the new blocking rule selectable button is selected on the home screen, interface 1600 of FIG. 16 is provided. Interface 1600 includes selectable buttons for a new number blocking, a new time blocking, or canceling a new blocking rule. Additional selectable buttons may also include new location blocking, new conditional blocking, and other blocking.

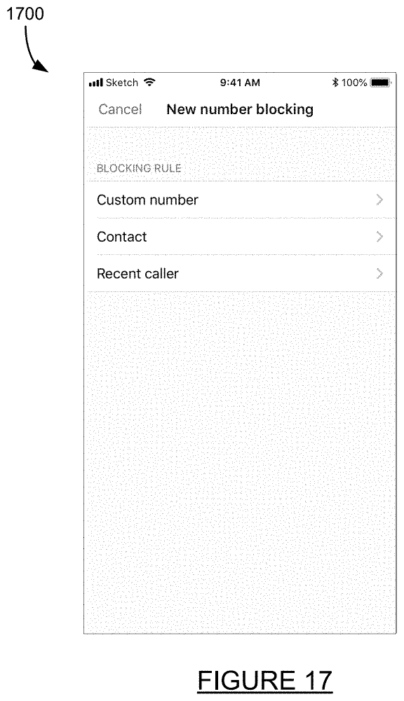

Upon receiving a new number blocking input from interface 1600, interface 1700 of FIG. 17 is provided. Interface 1700 is an interface for blocking a new number, and provides selectable inputs of a custom number, a contact, or a recent caller. In some instances, blocking a new number based on a custom number may include generating an expression to blocked numbers having a particular area code, a subset of numbers, or some other selection of numbers within a telephone number.

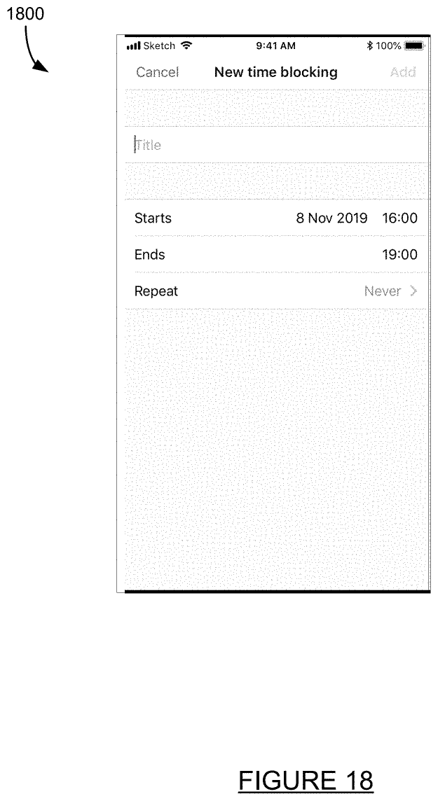

If a request is received to generate a new time blocking rule in interface 1700, a new time blocking interface 1800 of FIG. 18 may be provided to the user. Interface 1800 allows a user to input a title, specify a start time and date, specify an end time and date, and indicate how the time blocking can repeat if desired. For example, in interface 1800, a start time is set for Nov. 8, 2019, at 1600 hrs., and an ending time of 1900 hrs.

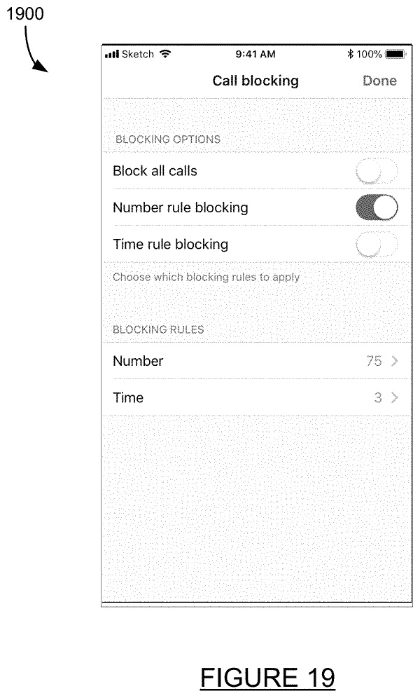

If, in the home screen user interface, user input is received on the call blocking icon, the mobile application will provide user interface 1900 of FIG. 19. In interface 1900, the interface provides global call blocking settings and provides a user with information about the rules currently set by the user. Additionally, location-based rules may be provided to the user as well. Interface 1900 displays blocking options for blocking all calls, number rule blocking, and time rule blocking, and provides blocking rules in categories of number blocking rules and time blocking rules.

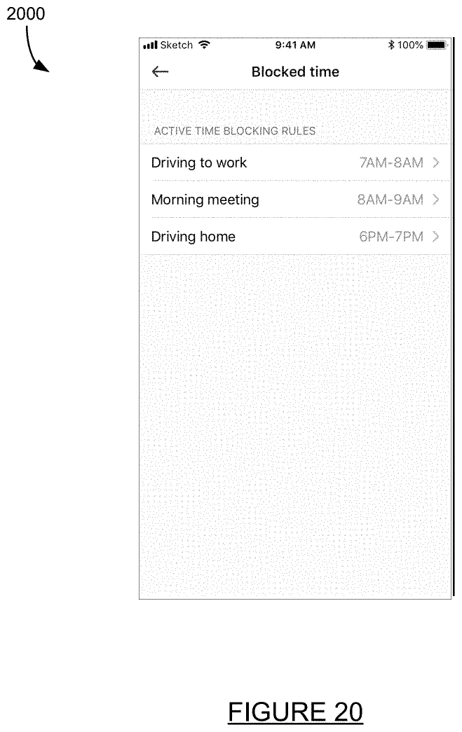

If the interface receives input to the time blocking rules, the user may be provided with a blocked time user interface 2000 of FIG. 20. The block time interface lists active time blocking rules. In the interface shown in FIG. 20, the active time blocking rules include a driving to work rule with a block time of 7:00 AM to 8:00 AM, a morning meeting rule with a block time of 8:00 AM to 9:00 AM, and a driving home blocked time rule with a time of 6:00 PM to 7:00 PM.

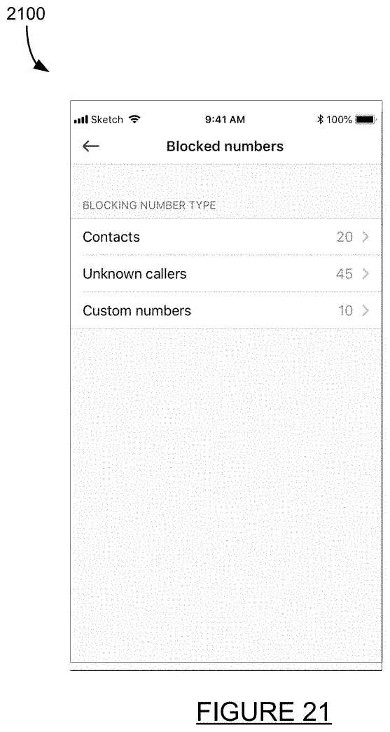

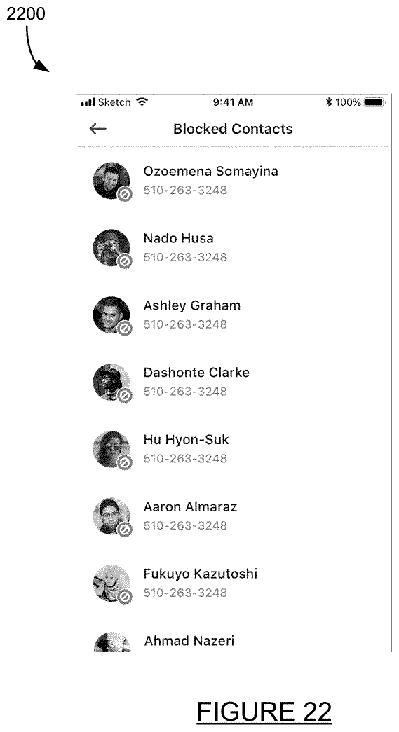

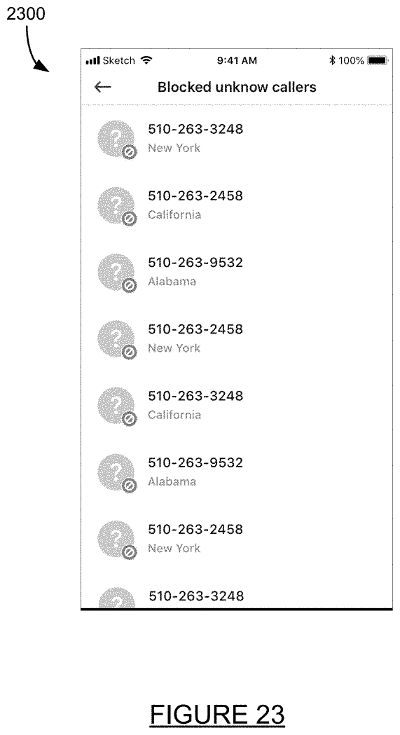

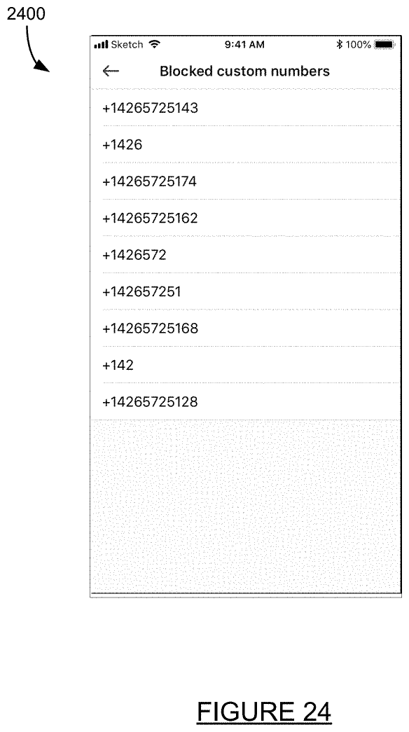

In interface 1900 of FIG. 19, if input is received selecting the number blocking rules, interface 2100 of FIG. 21 is provided to the user by the mobile application. Interface 2100 provides block numbers and categorizes the blocked numbers based on blocking number type. The displayed blocking number types include contacts, for which there are 20 rules, unknown callers, for which there are 45 rules, and custom numbers for which there are 10 rules. If a user, for example, selects “contacts” in the interface 2100, an interface such interface 2200 of FIG. 22 would be provided by the mobile application. Interface 2200 provides a list of blocked contacts for the logged in user. If, in interface 2100 of FIG. 21, a user selected unknown callers, interface 2300 of FIG. 23 would be provided with a list of blocked unknown callers. If, in FIG. 21, input is received for the custom number's rules, the user would be provided with interface 2400 of FIG. 24, in which the user would see the regular expression-based rules set by the user.

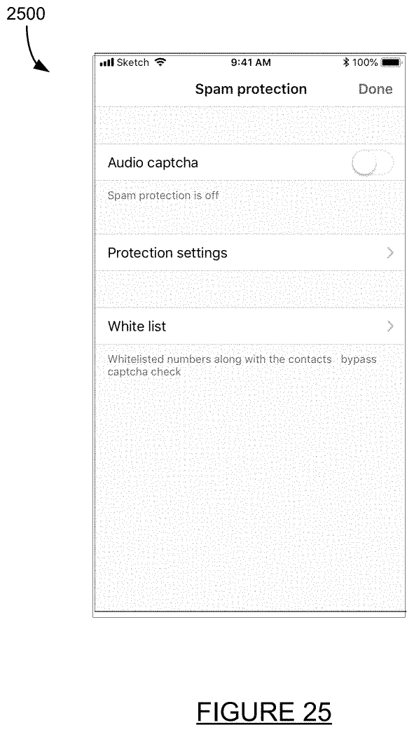

The interfaces of FIGS. 25 to 29 are exemplary interfaces that may be used for configuring spam telephone call protection. In user interface 1500 of FIG. 15 associated with a home interface, the application may receive a selection through the interface of the spam protection icon. Upon receiving input of the spam protection icon, interface 2500 of FIG. 25 may be provided by the mobile application. The spam protection user interface 2500 may be used to set spam blocking settings. In the exemplary interface illustrated in FIG. 25, a user can enable an audio captcha challenge, configure protection settings, and set up a white list. A user can provide input to allow all calls to proceed, a challenge that callers must complete or solve to reach the intended phone number, and configure white list of numbers. In some instances, all contacts may be white listed by default, but a user may change a contact to be blocked as well. In some instances, a user may set up a robo caller to connect with the user's phone, for example for automatic Dr. appointment reminders, school notifications, and other desirable Robo calls. In some instances, these robo calls may be added to the colors white list.

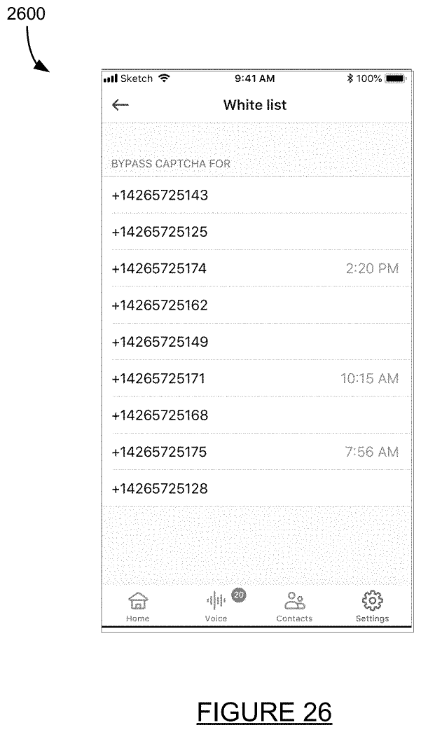

If, in the interface of FIG. 25, input is received to select a white list, a user may be provided with interface 2600 of FIG. 26. Interface 2600 provides a list of phone numbers that are white listed. The white listed phone numbers in the white list interface can be edited such that each number can be deleted, and additional numbers can be added.

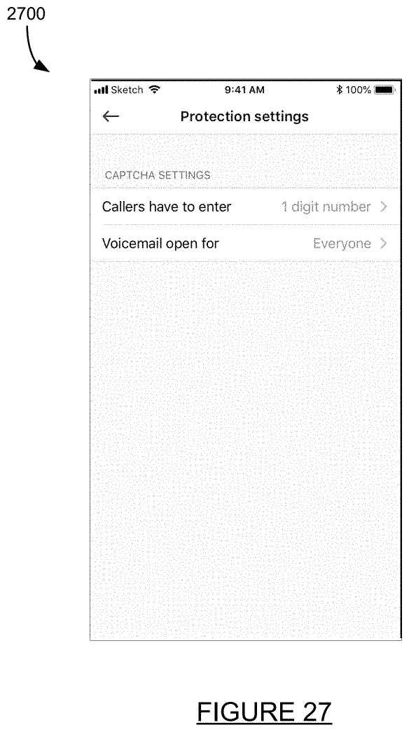

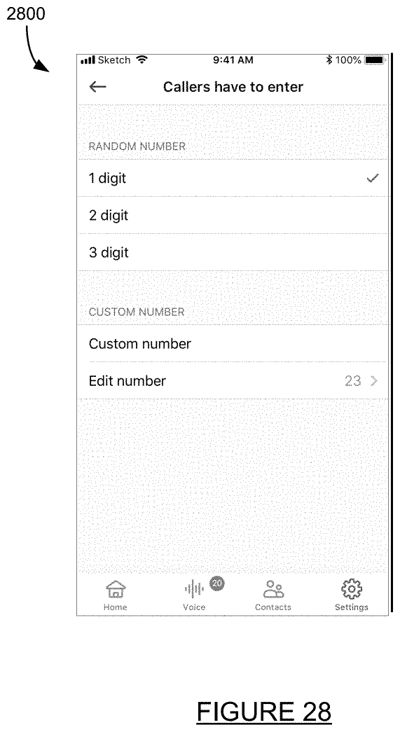

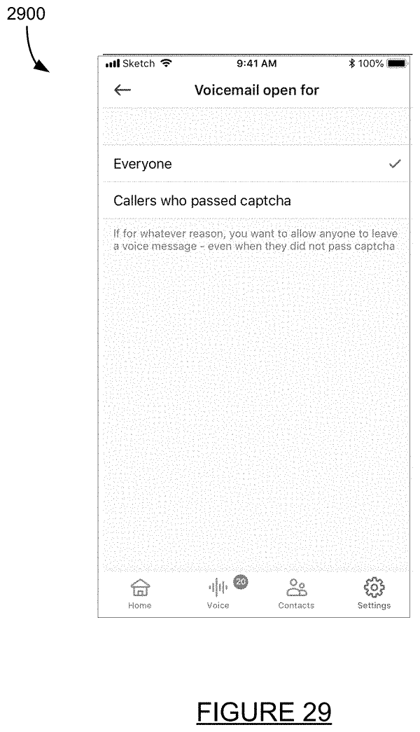

If input is received for protection settings of the interface of FIG. 25, interface 2700 of FIG. 27 will be provided by the mobile application. In this protection settings interface, a user can provide customized challenges which must be satisfied by unknown callers. In some instances, callers will enter digits using DTMF tones on their calling device to provide a response to a challenge. For example, in interface 2700, the captcha settings indicate that callers must enter a one-digit number as a challenge, and voicemail is open for everyone. If input is received on the captcha setting for “callers have to enter,” interface 2800 of FIG. 28 is provided by the mobile application. Interface 2800 of FIG. 28 allows users to indicate random numbers to be provided randomly via audio to a caller. In the interface of 2800, the random number is currently selected as a one-digit number, though two-digit numbers and three-digit numbers may also be used. Further, in interface 2800, a custom number may be selected to be presented to a caller as a challenge. If in interface 2700 input is received for “voicemail open for,” interface 2900 of FIG. 29 may be provided to the user by the mobile application. In the voicemail open for interface, input can be received to select everyone or callers to pass the captcha to be passed to voicemail.

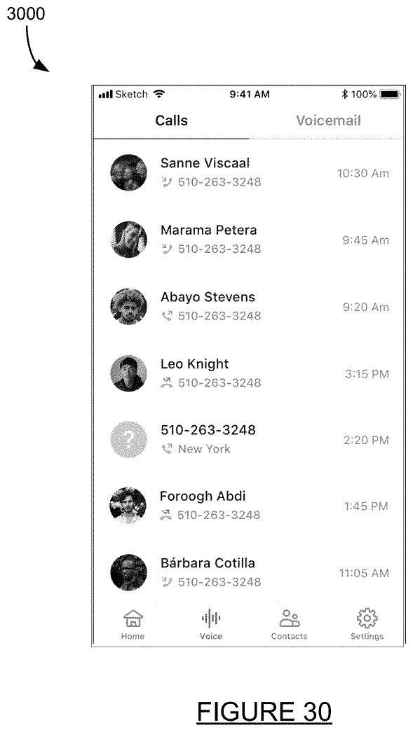

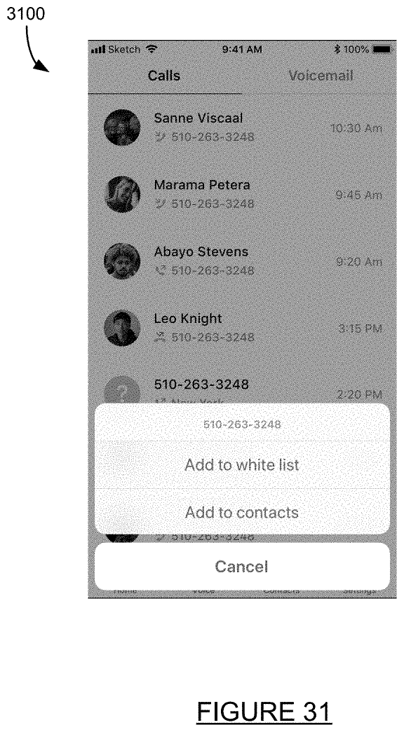

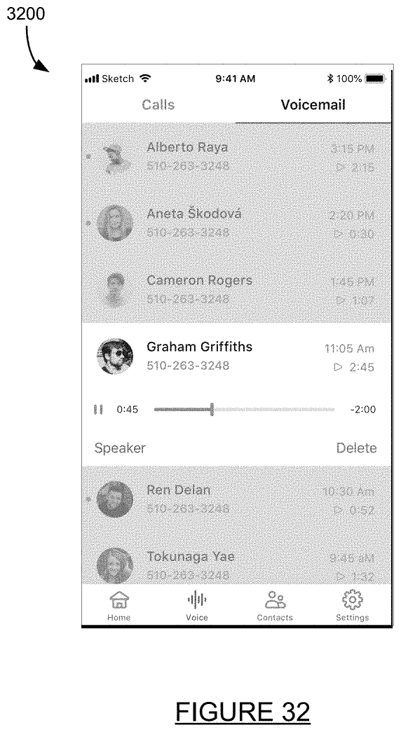

On the home screen, when an input is received for voicemail along the bottom of interface 1500, user interface 3000 of FIG. 30 is provided to a user. In interface 3000, user can view the calls received, outgoing calls, and missed calls. If input is received on a number within the interface of FIG. 30, the user will be provided with an option to add that number two the users contacts or white list. This is illustrated in interface 3100 of FIG. 31. If, in the interface of FIG. 31, input is received selecting voicemail, interface 3200 of FIG. 32 is provided. Through the current spam protection and rule-based telephone call handling, each and every voicemail is either from a human or a user approved Robo source.

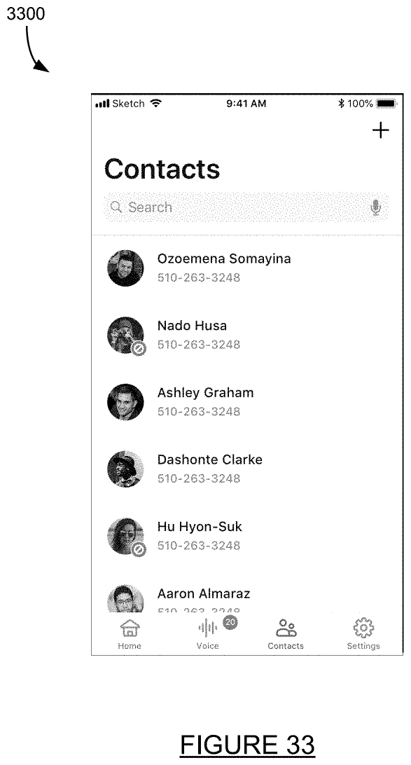

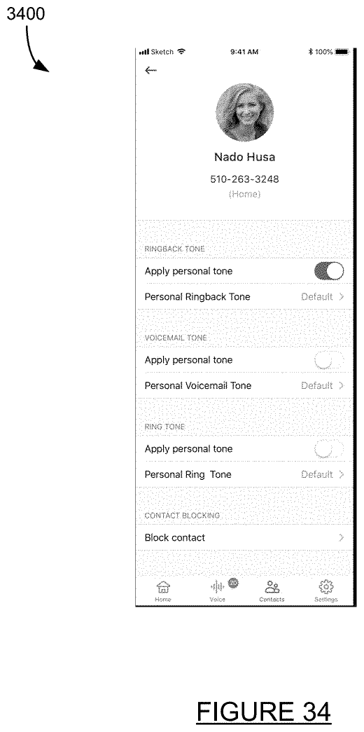

If, on home interface 1500, a user selects the contacts icon towards the bottom of the interface, the user will be provided with interface 3300 of FIG. 33. In interface 3300, the user will be provided contacts and can add contacts. If a user selects a particular contact in the interface 3300, mobile application will provide interface 3400 of FIG. 34. In the interface 3400 of FIG. 34, user can personalize the experience that the particular caller will encounter when calling the user's telephone number. For example, input can be received from a user to specify that the contact has a personal ring back tone, a personal voicemail, and other features. In particular, interface 3400 allows for a personal tone, personal ring back tone, personal voicemail tone, personal ring tone, and optionally can be blocked.

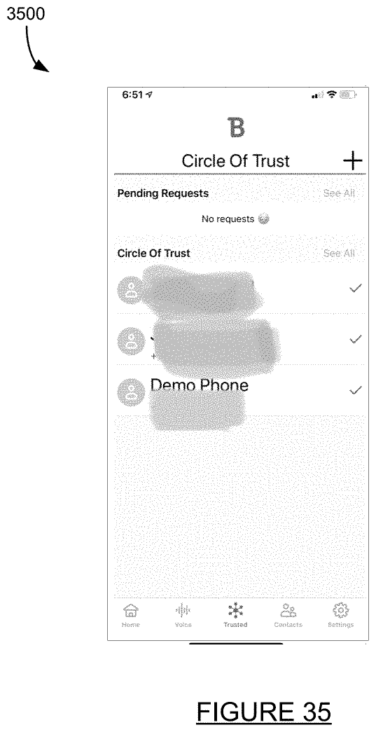

FIGS. 35-41 include interfaces related to trusted contact configuration and information access. The trusted contact feature will allow users of the platform to share their location, incoming call logs, voicemails, recordings, and other data to trusted contacts within their network. The trusted contact feature also allows a user to set up a geo-fence notification that will allow the user to be notified if a person within their trusted contacts is at a particular location. In some instances, the trusted contact feature can be used in an employment agreement, wherein several employees are trusted contacts of a supervisor or business owner.

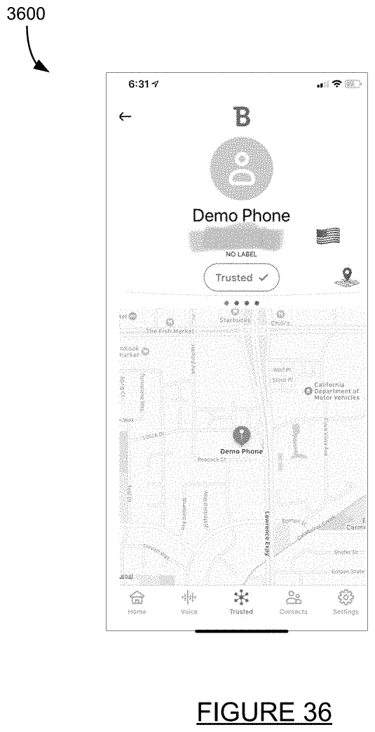

FIG. 35 provides a list of trusted contacts for a particular user. The interface 3500 of FIG. 35 list pending requests, and quote circle of trust, trusted contacts for the user. If an input is received for a particular user in interface 3500, a mobile application can provide interface 3600 of FIG. 36. Interface 3600 provides a map of for that particular trusted contact is currently located. This information may be seen by the user for which the trusted contact is within his “circle of trust” of trusted contacts.

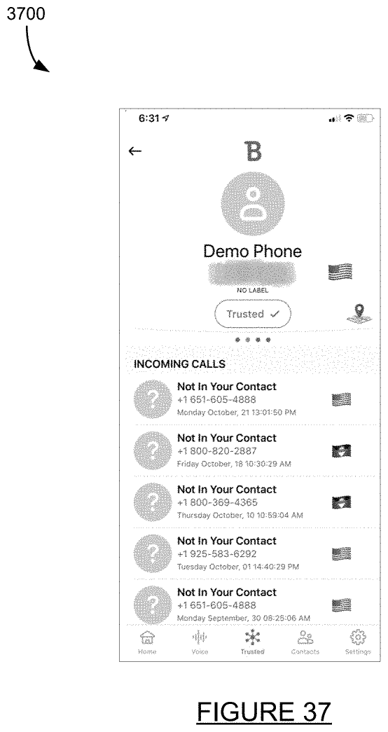

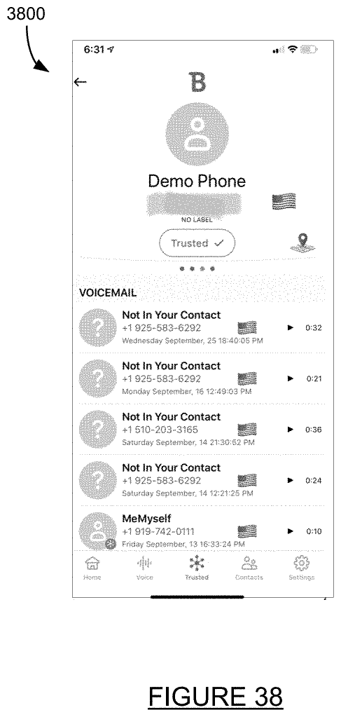

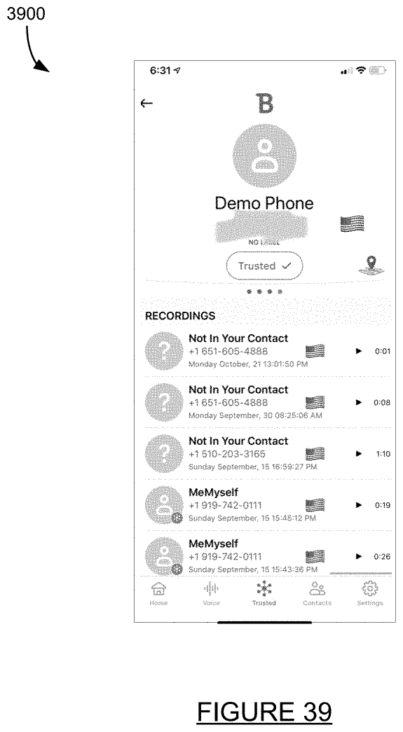

FIG. 37 illustrates an exemplary interface 3700 that list an incoming call log for a selected trusted contact. The interface indicates the user is a trusted user and list the incoming calls for that trusted user. FIG. 38 illustrates interface 3800 which lists the voicemails for the trusted user. The voicemail information indicates, for each voicemail, the name of the entity leaving a voicemail, the phone number, the length of the voicemail, and the date and time of the voicemail. Upon selecting an entry in the list of voicemails, the user viewing the trusted users' voicemails may listen to the selected voicemail. FIG. 39 illustrates interface 3900 which provides recordings of conversations of the trusted contact. The recordings information includes a name of a contact, contact phone number, length of conversation, and date of the conversation. Upon selecting a recording within the trusted users' recordings, the user may listen to the trusted users phone recordings.

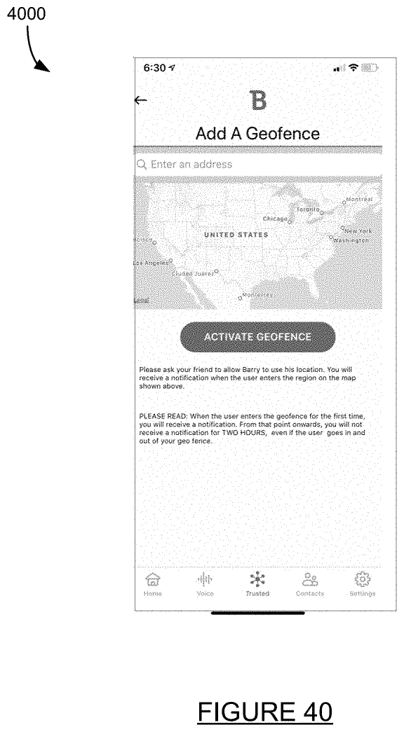

FIG. 40 illustrates interface 4004 adding a geo-fence. Interface 4000 can receive input of a particular address for which to activate a geo-fence through the “activate geo-fence” selectable button on the interface upon activating the geo-fence, the user may determine when the trusted contact comes within the geo-fence.

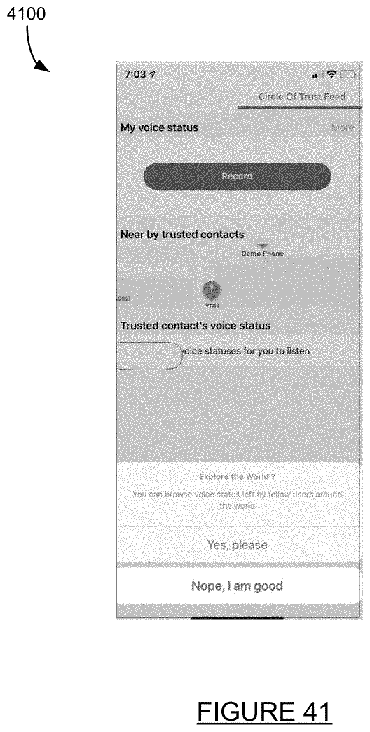

FIG. 41 illustrates interface 4100 for setting a voice status. A voice status allows one user to listen to another user's conversation. A user may control settings to allow his voice status to be accessed by trusted contacts or other contacts.

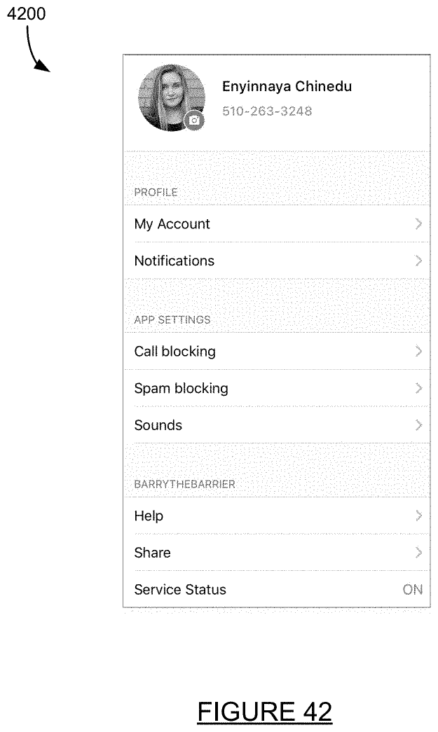

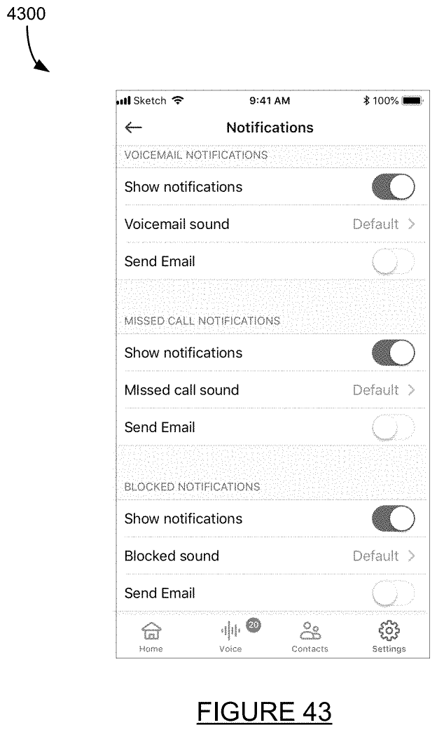

FIG. 42 illustrates interface 4200 for configuring settings for the mobile application and the user's account. The user based configure settings such as account settings, notifications, call blocking, spam blocking, sounds, and may also access help tips, sharing preferences, and service status. If input is received to select notifications on interface 4200, interface 4300 of FIG. 43 is provided to the user by the mobile application. Interface 4300 allows notification settings to be configured, including voicemail, missed call notifications, and blocked notifications. Voicemail notifications include a setting to show notifications, and send email. Missed call notifications including notification as to whether to show notifications for missed calls, set a missed call sound, and send email regarding missed calls. Blocked notifications may be configured as whether to show notifications, a sound to play when a call is blocked, and whether to send an email when a call is blocked.

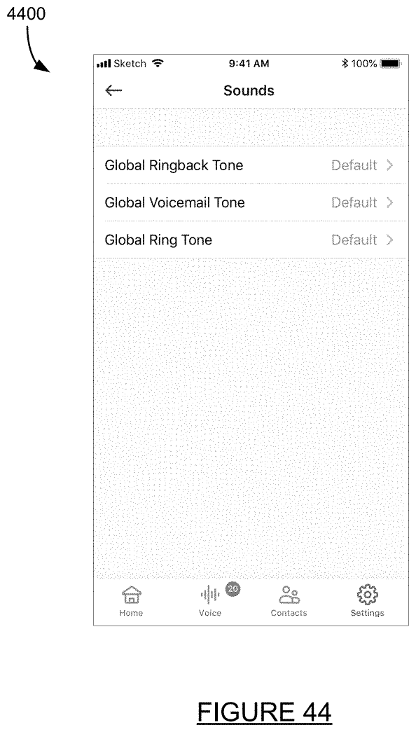

If in interface 4200 input is received to configure sound settings, the interface 4400 of FIG. 44 is provided by the mobile application. Interface 4400 allows a user to set a global ring back tone, a global voicemail tone, and a global ring tone.

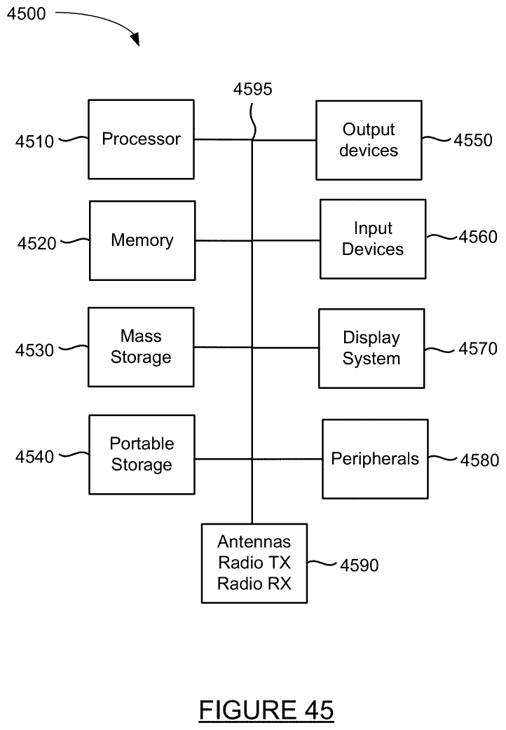

FIG. 45 is a block diagram of a computing environment for implementing a computing device. System 4500 of FIG. 45 may be implemented in the contexts of a machine that implements calling device 100, calling device 130, and sever 120. The computing system 4500 of FIG. 45 includes one or more processors 4510 and memory 4520. Main memory 4520 stores, in part, instructions and data for execution by processor 4510. Main memory 4520 can store the executable code when in operation. The system 4500 of FIG. 45 further includes a mass storage device 4530, portable storage medium drive(s) 4540, output devices 4550, user input devices 4560, a graphics display 4570, and peripheral devices 4580.

The components shown in FIG. 45 are depicted as being connected via a single bus 4590. However, the components may be connected through one or more data transport means. For example, processor unit 4510 and main memory 4520 may be connected via a local microprocessor bus, and the mass storage device 4530, peripheral device(s) 4580, portable storage device 4540, and display system 4570 may be connected via one or more input/output (I/O) buses.

Mass storage device 4530, which may be implemented with a magnetic disk drive, an optical disk drive, a flash drive, or other device, is a non-volatile storage device for storing data and instructions for use by processor unit 4510. Mass storage device 4530 can store the system software for implementing embodiments of the present technology for purposes of loading that software into main memory 4520.

Portable storage device 4540 operates in conjunction with a portable non-volatile storage medium, such as a flash drive, USB drive, memory card or stick, or other portable or removable memory, to input and output data and code to and from the computer system 4500 of FIG. 45. The system software for implementing embodiments of the present technology may be stored on such a portable medium and input to the computer system 4500 via the portable storage device 4540.

Input devices 4560 provide a portion of a user interface. Input devices 4560 may include an alpha-numeric keypad, such as a keyboard, for inputting alpha-numeric and other information, a pointing device such as a mouse, a trackball, stylus, cursor direction keys, microphone, touch-screen, accelerometer, wireless device connected via radio frequency, motion sensing device, and other input devices. Additionally, the system 4500 as shown in FIG. 45 includes output devices 4550. Examples of suitable output devices include speakers, printers, network interfaces, speakers, and monitors.

Display system 4570 may include a liquid crystal display (LCD) or other suitable display device. Display system 4570 receives textual and graphical information and processes the information for output to the display device. Display system 4570 may also receive input as a touchscreen.

Peripherals 4580 may include any type of computer support device to add additional functionality to the computer system. For example, peripheral device(s) 4580 may include a modem or a router, printer, and other device.

The system of 4500 may also include, in some implementations, antennas, radio transmitters and radio receivers 4590. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 4500 of FIG. 45 are those typically found in computer systems that may be suitable for use with embodiments of the present invention and are intended to represent a broad category of such computer components that are well known in the art. Thus, the computer system 4500 of FIG. 45 can be a personal computer, handheld computing device, smart phone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Android, as well as languages including Java, .NET, C, C++, Node.JS, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1. A method for processing an incoming phone call, the method comprising:
receiving, by a server, a call intended for a first phone number from a telephone network, the call originating from a first remote device associated with a calling number;
accessing one or more rules to apply to the received call before the call is accepted, the one or more rules accessed from account data by the server and associated with the first phone number, the server having access to a plurality of rule sets for a plurality of phone numbers, wherein at least two of the plurality of rule sets are different for at least two of the plurality of phone numbers,
wherein at least one of the rules is created by a user of the first phone number, the rule including a challenge type from two or more challenge types, a challenge, and an acceptable response to the challenge;
providing the challenge by the server to the originator of the call;
receiving a response by the server to the challenge from the originator of the call; and
determining whether to connect the call between the first remote device and a second remote device based on the response received by the server.

2. The method of claim 1, wherein the call is not connected and subsequent calls to the first phone number by the calling number are blocked if the response does not satisfy the challenge.

3. The method of claim 1, wherein the challenge is provided as an audio message over the call before the call to the first phone number is accepted.

4. The method of claim 1, wherein the response is received as an audio input.

5. The method of claim 1, wherein the one or more rules include a geographical limitation associated with the calling number.

6. The method of claim 1, wherein the one or more rules include a temporal limitation associated with the calling number.

7. The method of claim 1, wherein processing the call includes blocking the call if the response does not match a desired response associated with the puzzle.

8. The method of claim 1, wherein the network is a public switched telephone network.

9. A non-transitory computer readable storage medium having embodied thereon a program, the program being executable by a processor to perform a method for processing an incoming phone call, the method comprising:
receiving, by a server, a call intended for a first phone number from a telephone network, the call originating from a first remote device associated with a calling number;
accessing one or more rules to apply to the received call before the call is accepted, the one or more rules accessed from account data by the server and associated with the first phone number, the server having access to a plurality of rule sets for a plurality of phone numbers, wherein at least two of the plurality of rule sets are different for at least two of the plurality of phone numbers,
wherein at least one of the rules is created by a user of the first phone number, the rule including a challenge type from two or more challenge types, a challenge, and an acceptable response to the challenge;
providing the challenge by the server to the originator of the call;
receiving a response by the server to the challenge from the originator of the call; and
determining whether to connect the call between the first remote device and a second remote device based on the response received by the server.

10. The non-transitory computer readable storage medium of claim 9, wherein the call is not connected and subsequent calls to the first phone number by the calling number are blocked if the response does not satisfy the challenge.

11. The non-transitory computer readable storage medium of claim 9, wherein the challenge is provided as an audio message over the call before the call to the first phone number is accepted.

12. The non-transitory computer readable storage medium of claim 9, wherein the response is received as an audio input.

13. The non-transitory computer readable storage medium of claim 9, wherein the one or more rules include a geographical limitation associated with the calling number.

14. The non-transitory computer readable storage medium of claim 9, wherein the one or more rules include a temporal limitation associated with the calling number.

15. The non-transitory computer readable storage medium of claim 9, wherein processing the call includes blocking the call if the response does not match a desired response associated with the puzzle.

16. The non-transitory computer readable storage medium of claim 9, wherein the network is a public switched telephone network.

17. A system for processing an incoming phone call, comprising: a server comprising one or more processors, memory, and a plurality of modules stored in memory and executable by the one or more processors to receive, by a server, a call intended for a first phone number from a telephone network, the call originating from a first remote device associated with a calling number, access one or more rules to apply to the received call before the call is accepted, the one or more rules accessed from account data by the server and associated with the first phone number, the server having access to a plurality of rule sets for a plurality of phone numbers, wherein at least two of the plurality of rule sets are different for at least two of the plurality of phone numbers, wherein at least one of the rules is created by a user of the first phone number, the rule including a challenge type from two or more challenge types, a challenge, and an acceptable response to the challenge, provide the challenge by the server to the originator of the call, receive a response by the server to the challenge from the originator of the call, and determine whether to connect the call between the first remote device and a second remote device based on the response received by the server.

18. The system of claim 17, wherein the call is not connected and subsequent calls to the first phone number by the calling number are blocked if the response does not satisfy the challenge.

19. The system of claim 17, wherein the challenge is provided as an audio message over the call before the call to the first phone number is accepted.

20. The system of claim 17, wherein the response is received as an audio input.
